(19) United States
(12) Patent Application Publication
(10) Pub. No.: US 2008/0275715 A1
(43) Pub. Date: Nov. 6, 2008

(54) SYSTEM AND METHOD FOR ONLINE INTERACTIVE SCHEDULING AND APPRAISAL

(76) Inventor: Erik Ahroon, Newport Beach, CA (US)

Correspondence Address: OC PATENT, P.C;ATTN: MATT MUSHET, ESQ, 6332 ROYAL GROVE, HUNTINGTON BEACH, CA, 92648, US

(21) Appl. No.: 11/744,195

(22) Filed: May 3, 2007

(51) Int. Cl. G06Q 50/00; G06F 3/00

(52) U.S. Cl. 705/1; 715/700

(57) ABSTRACT

A system and method is disclosed for allowing artists to schedule and publicize their appearances and tours at smaller venues while providing consumers with access to these performances and the ability to rate them. An artist, venue or consumer may sign in to a website where they may select their desired purpose. Artists may schedule their tours and see reviews from fans. Consumers may make arrangements to see live performances based on the artists schedule and online ratings. Additionally, record labels may view the same ratings from concerts and music sales and use this information to appraise prospective bands for signing with their label. The use of this business method will allow smaller underground artists to attain a global presence and provide for a widespread conglomeration of the music scene and music industry.

### FIELD OF INVENTION

The present invention relates to the field of informational organization and display. More specifically, the invention relates to the technical field of online scheduling and rating for artists and venues.

### BACKGROUND OF THE INVENTION

Around the world, there are thousands of artists who struggle to showcase their talent in a live environment due to the massive amount of searching and coordinating with venues that is required. The daily interaction with venues creates a huge barrier for artists to market themselves efficiently in a live environment. Similarly, hundreds of thousands of smaller venues across the globe that are willing to host live acts remain untapped because they lack the resources to reach promising artists, This problem of coordinating between artists and venues harms the parties directly involved, but it also harms the consumer by limiting their exposure to musical diversity.

Currently, an artist may solve their marketing problem by signing with a record label. Professional assistance may be able to take the artist's talent to the next level and provide access to more prestigious venues. However, securing an initial contract from a record label requires time, money and most of all, patience. These hurdles alone drive many artists away from trying to succeed in the music industry. Many musicians that do have the required talent and aspiration to be the next big star lack the resources or networks to properly self promote their talent. This leaves a large pool of frustrated musicians and a large amount of unknown talent that goes to waste. The talent eventually fades with popular trends or forces an artist to remain underground with little hope for success.

Music is the world's universal form of communication. It touches every person of every culture on the globe to the tune of forty billion dollars annually. The industry employs thousands of people, including singers, musicians, producers, sound engineers, record promoters and retail salespersons. Recently, the music industry has changed drastically because musicians now have the ability to digitize their music and take advantage of websites that allow free global marketing, polling, statistical tracking and sales. With artists now developing and managing their own fan bases and with full featured artist digital stores enabled by web services, a new era has evolved within the industry. The internet revolution has changed the market from one requiring record label approval for success to a new global market based on consumer reactions for success. The subject of the current patent uses this new market paradigm to solve many of the problems between smaller artists and venues by providing interaction while putting the power to decide popularity in the hands of the consumer.

### SUMMARY OF THE INVENTION

A system and method is disclosed for allowing artists to schedule and publicize their appearances and tours at smaller venues while providing consumers with access to these performances and the ability to rate them. An artist, venue or consumer may sign in to a website where they may select their desired purpose. Artists may schedule their tours and see reviews from fans. Consumers may make arrangements to see live performances based on the artists schedule and online ratings. Additionally, record labels may view the same ratings from concerts and music sales and use this information to appraise prospective bands for signing with their label. The use of this business method will allow smaller underground artists to attain a global presence and provide for a widespread conglomeration of the music scene and music industry.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an organizational chart of a preferred embodiment of the present invention.

FIG. 2 illustrates a flowchart showing access by an artist to the embodiment shown in FIG. 1.

FIG. 3 illustrates a flowchart showing access by a consumer to the embodiment shown in FIG. 1.

### DETAILED DESCRIPTION OF THE PREFERRED EMBODIMENT

In the following description of the various embodiments, reference is made to the accompanying drawings, which form a part hereof, and in which is shown by way of illustration various embodiments in which the invention may be practiced. It is to be understood that other embodiments may still be utilized and structural and functional modifications may be made without departing from the scope and spirit of the present invention.

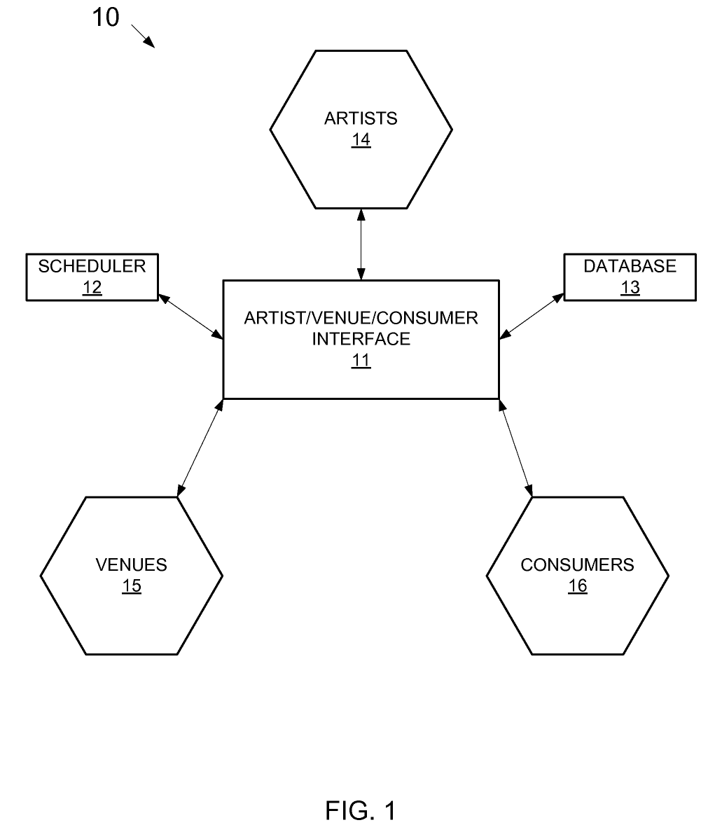

Referring to FIG. 1, a preferred embodiment of device 10 is shown. Device 10 includes interface 11 which coordinates the appearances of various artists 14 at various venues 15. Artists 14 are given access to interface 11 preferably through a website which can be accessed on any computer or personal electronic device. Artists 14 can then view available venues 15 and schedule the time and date of appearances or tours. They can also view a calendar for any specific venue of when other artists are playing. Venues 15 are similarly given access to interface 11 for the purpose of confirming artistic performances and creating line-ups. Scheduler 12 is capable of operating in real time and auto-populating the confirmed list of performances. It also has interaction with database 13.

Consumers 16 also have the ability to use interface 11 to access database 13 of musical, theatrical and entertainment related performances. Consumers 16 will view appearances that have been confirmed through scheduler 12 and select any artists 14 or venues 15 shown for the purpose of chatting, reviewing ratings, attending performances, buying tangibles including concert tickets, theatre tickets or works of art, or rating any previously attended events. When consumers 16 have rated events, they will be published to the general public and members of interface 11. Interface 11 will also have the capability to capture information, including but not limited to the amounts of revenues produced from various product sales, artistic appearances and venue events.

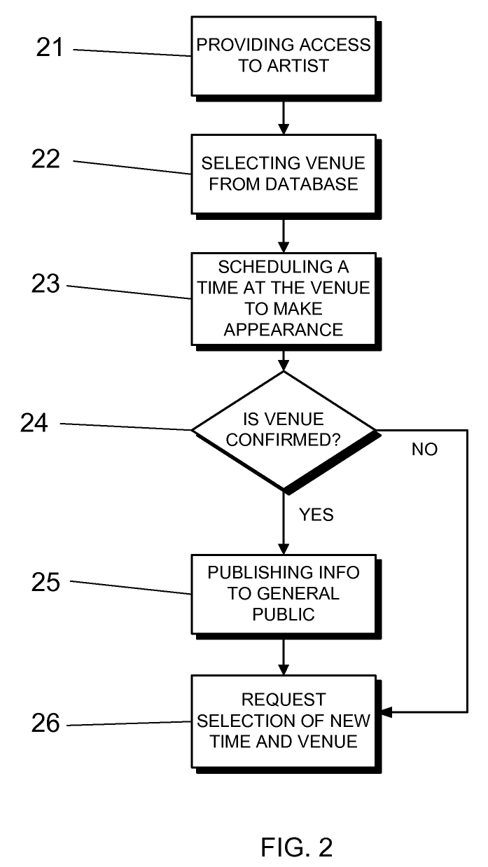

Now referring to FIG. 2, a flowchart showing access to an artist of the preferred embodiment is shown. In step 21, membership access is provided to an artist. The artist will preferably access the system through a website. The artist will select a venue from a database containing available venues in step 22. Then, in step 23, the artist will schedule the time and date of an appearance that they wish to make at the selected venue as a request. In step 24, the request is either confirmed or denied by the selected venue. Once the venue confirms the time and date of the artist, this information will be published to the general public in step 25. The artist will then be returned to select a new venue as shown in step 26. If however, in step 24, the venue denies the request, the artist will be informed of the decision and asked to select a new venue, time or date. It can also be envisioned that the artist and venue have reverse roles with the venue selection being confirmed by the artist.

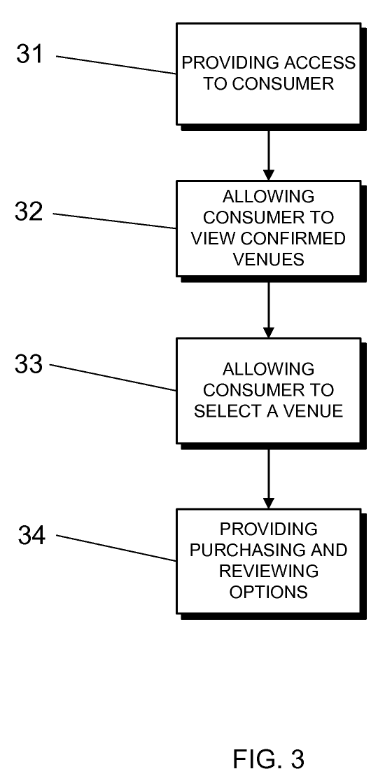

Now referring to FIG. 3, a flowchart showing access to a consumer of the preferred embodiment is shown. In step 31, membership access is provided to a consumer. The consumer will preferably access the system through a website. The consumer will view confirmed appearances at available venues in step 32. Then, in step 33 the consumer will be allowed to select a particular venue for the purpose of chatting, reviewing ratings, attending performances, buying tangibles including concert tickets, theatre tickets or works of art, or rating any previously attended events. The consumer may then perform any of these options in step 34.

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described apparatus and techniques. Thus, the spirit and scope of the invention should be construed broadly as set forth in the appended claims.

What is claimed is:

1. An interface which allows artists, venues and consumers to share information comprising:
a website;
a database of music venues accessible from the website;
an online scheduler accessible from the website to book the venues; and
a means to view a scheduled appearance at any one of the venues from the website.

2. The interface of claim 1 wherein the website can be viewed via a desktop computer, laptop computer, personal digital assistant, cellular telephone or portable music player.

3. The interface of claim 1 wherein the online scheduler can be sorted by artist, venue, geographic area or date.

4. The interface of claim 1 wherein the online scheduler functions in real time by auto populating a confirmed list of performances.

5. The interface of claim 1 wherein the means to view the scheduled appearance comprises a calendaring system.

6. The interface of claim 1 wherein the means to view the scheduled appearance comprises a display of any previous ratings.

7. A method for using the device of claim 1 to schedule at least one appearance at a venue comprising the steps of:
providing a user with access to the interface, allowing the user to select a venue from the database;
allowing the user to schedule a time at the venue to make the at least one appearance;
allowing the venue to sign in and confirm the at least one appearance; and
publishing a confirmed appearance to the public.

8. The method of claim 7, further comprising the steps of:
providing a consumer with access to the interface;
allowing the consumer to view the confirmed appearance;
providing options to the consumer pertaining to a selected appearance; and
allowing the consumer to rate the selected appearance at a future time.

9. The method of claim 7, further comprising the step of allowing the public to view any ratings or revenue of the venue or the user.
